(19) United States
(12) Patent Application Publication
(10) Pub. No.: US 2015/0074393 A1
(43) Pub. Date: Mar. 12, 2015

(54) Method, Apparatus, and System for Implementing Media Data Processing

(71) Applicant: Huawei Technologies Co., Ltd., Shenzhen (CN)

(72) Inventor: Shaobo Zhang, Shenzhen (CN)

(21) Appl. No.: 14/542,334

(22) Filed: Nov. 14, 2014

Related U.S. Application Data
(63) Continuation of application No. PCT/CN2013/075779, filed on May 17, 2013.

(30) Foreign Application Priority Data
May 29, 2012 (CN) 201210171388.2

(51) Int. Cl. H04L 29/06

(52) U.S. Cl. CPC H04L 63/0435
USPC 713/167

(57) ABSTRACT

Some embodiments disclose a method, an apparatus, and a system for implementing media data processing. A method includes dividing media data into several data blocks and selecting a part of the several data blocks using a preset rule shared with a requester. The method also includes encrypting the selected part of the several data blocks and sending the encrypted part of the several data blocks and another unencrypted part of the several data blocks to the requester. The requester can determine the encrypted part of the several data blocks according to the preset rule.

This application is a continuation of International Application No. PCT/CN2013/075779, filed on May 17, 2013, which claims priority to Chinese Patent Application No. 201210171388.2, filed on May 29, 2012, both of which are incorporated herein by reference in their entireties.

### TECHNICAL FIELD

The present invention relates to the field of data transmission technologies, and in particular, to a system and method for implementing media data processing.

### BACKGROUND

Currently, with development of computer and network technologies, in a media service such as streaming media, video data, audio data, another multimedia data, or the like usually is transmitted using a network. In view of security, only a user who is authorized or obtains a key can view and use media data, and an unauthorized user cannot normally view or use the media data. Therefore, in general, media data is transmitted in an encrypted form and, at the same time, a key is transferred to an authorized user through a secure channel.

However, in a media service, a protection object is media data, and protection for the media data and that for text data are different. For the text data, there is a tight context association and if any part is unprotected it is likely to cause content leaking, or provide clues for decryption, thereby threatening content security. Therefore, it is required to perform overall encryption to satisfy a security requirement. For the media data such as video data or audio data, in general, information capacity is relatively large and, if overall encryption is performed, security can also be ensured. However, during data encryption and decryption, a large amount of computation is required, a large number of resources are consumed, and relatively high requirements are imposed on computing power, a power supply, and the like. These power requirements are especially important to a handheld device, such as a mobile phone or a tablet computer. Therefore, effectively reducing resource consumption in a process of processing media data encryption and decryption is a key issue that needs to be addressed in a current media service.

### SUMMARY OF THE INVENTION

Embodiments of the present invention provide a method, an apparatus, and a system for implementing media data processing, which can effectively reduce a system resource overhead on a premise that media data security is ensured. To resolve the foregoing problem, the embodiments of the present invention provide technical solutions according to the following.

According to one aspect, a method for implementing media data processing is provided. The method includes dividing media data into several data blocks and selecting a part of the several data blocks by using a preset rule. The method further includes encrypting the selected part of the several data blocks and, when a data acquiring request from a requester is received, sending requested data to the requester. The requested data includes the encrypted part of the several data blocks, or an unencrypted data block in the several data blocks, or the unencrypted data block in the several data blocks and the encrypted part of the several data blocks. The method also includes sharing the preset rule with the requester so that the requester can determine the encrypted part of the several data blocks according to the preset rule.

According to another aspect, a method for implementing media data processing is provided. The method includes receiving media data processed by an encryption device, determining an encrypted data block in the media data by using a preset rule shared with the encryption device, and performing decryption processing on the encrypted data block to obtain original media data.

According to another aspect, an apparatus for implementing media data processing is provided. The apparatus includes a dividing unit, a selecting unit, an encrypting unit, and a sending unit. The dividing unit is configured to divide media data into several data blocks. The selecting unit is configured to select, by using a preset rule, a part of the several data blocks obtained through dividing by the dividing unit. The encrypting unit is configured to encrypt the part of the several data blocks selected by the selecting unit. The sending unit is configured to send the encrypted part of the several data blocks and an unencrypted data block in the several data blocks to the requester when a data acquiring request from a requester is received. The selecting unit and the requester share the preset rule, and the requester can determine the encrypted part of the several data blocks according to the preset rule.

According to another aspect, an apparatus for implementing media data processing is provided. The apparatus includes a receiving unit, a distinguishing unit, and a decrypting unit. The receiving unit is configured to receive media data processed by an encryption device. The distinguishing unit is configured to determine an encrypted data block in the media data received by the receiving unit by using a preset rule shared with the encryption device. The decrypting unit is configured to perform a decryption operation on the encrypted data block determined by the distinguishing unit.

According to another aspect, a system for implementing media data processing is provided. The system includes a first processing device and a second processing device. The first processing device is configured to divide media data into several data blocks, select a part of the several data blocks by using a preset rule shared with the second processing device, and encrypt the selected part of the several data blocks. The second processing device is configured to receive media data processed by an encryption device and perform decryption processing on the encrypted data block to obtain original media data after an encrypted data block in the media data is determined by using the preset rule shared with the first processing device.

It may be learned that, by using a method, an apparatus, and a system in embodiments described herein, partial encryption is performed on media data so that transmitted data combines encrypted data and unencrypted data and a requester decrypts only an encrypted part of the several data. Thereby, an embodiment method, apparatus, or system may effectively reduce a system resource overhead in a case in which media data security is ensured.

### BRIEF DESCRIPTION OF DRAWINGS

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 illustrates a schematic flowchart of a method for implementing media data processing according to an embodiment of the present invention;

FIG. 2 illustrates another schematic flowchart of a method for implementing media data processing according to an embodiment of the present invention;

FIG. 3 illustrates still another schematic flowchart of a method for implementing media data processing according to an embodiment of the present invention;

FIG. 4 illustrates a schematic structural diagram of an apparatus for implementing media data processing according to an embodiment of the present invention; and

FIG. 5 illustrates another schematic structural diagram of an apparatus for implementing media data processing according to an embodiment of the present invention.

### DETAILED DESCRIPTION OF ILLUSTRATIVE EMBODIMENTS

The following clearly describes technical solutions in embodiments of the present invention with reference to the accompanying. Apparently, the described embodiments are merely a part rather than all of the embodiments of the present invention. All other embodiments obtained by a person of ordinary skill in the art based on the embodiments of the present invention shall fall within the protection scope of the present invention.

It is known that for text data, if partial encryption is used, leaking of a part of a text message may occur and, further, an encryption clue of an encrypted part of texts may be obtained from an unencrypted plain text according to context, so as to decrypt a text message. For a complex media type, it is much more difficult to speculate one part of media data according to another part of the media data. Speculation is of no significance to consumers of media content. In addition, a predicative coding technology is widely used in modern video and audio coding, a dependence relationship exists between data and previous data in media data, and unencrypted data is likely to depend on encrypted data. Therefore, the unencrypted data is not necessarily useful for an unauthorized user. On a basis of this, a basic idea of the present application lies in that partial encryption is performed on media data such that transmitted data combines encrypted data and unencrypted data. Thus, a requester decrypts only an encrypted part of the transmitted data. Thereby, system resource overhead may be effectively reduced while ensuring media data security.

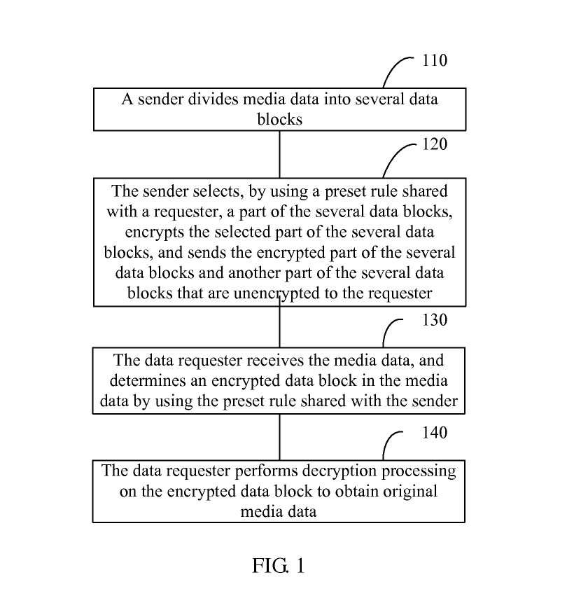

Embodiment 1 provides a method for implementing media data processing. The method is described below in reference to FIG. 1.

In step 110, a sender divides media data into several data blocks. Specifically, in this embodiment, a data block generated by dividing the media data by the sender may be of a fixed length, and may also be of an unfixed length. Certainly, a person of ordinary skill in the art easily understands that, for division of the media data, another manner in the prior art may be used. This embodiment sets no specific limitation thereto, and details are not described herein again.

In step 120, the sender selects a part of the several data blocks using a preset rule shared with a requester. The sender encrypts the selected part of the several data blocks, and sends the encrypted part of the several data blocks and another part of the several data blocks that are unencrypted to the requester.

In this embodiment, the preset rule used by the sender is the same as the preset rule which is mentioned in the following step and used by the requester. For the sender and the requester, the preset rule is the same. Therefore, similar to a key, the preset rule may be used as a secret shared by both receiving and sending parties. In addition, both receiving and sending parities may share the preset rule in the following manners which are not limited hereto. The preset rule may be sent to the requester through a secure channel. The requester may be notified of the preset rule in a public manner. A same rule as that of the requester may be preset for the sender. The preset rule may be negotiated and determined by exchanging information with the requester. In other embodiments, other or similar approaches for providing a shared preset rule may be used. Details are not described again in this specification. For the requester, a decryption device is used as an example for description in the following. In addition, it should be noted that in this embodiment, a quantity of the selected part of the several data blocks may be less than a total quantity of the several data blocks in order for partial encryption to be implemented.

It should be noted that in this embodiment, the preset rule may be used in the following manners to complete a selection operation, but manners are not limited to the following manners.

In this embodiment, a random number generator may be used to complete the selection operation. In this case, the preset rule may include a random number generation algorithm and may further include a parameter such as a random number generating initial value. Specifically, a 0-1 random number generator is used, an input parameter is a seed of the random number generator and an occurrence probability p of 1 or an occurrence probability q of 0, where p+q=1. The random number generator is run, and a 0-1 sequence with a length of N is generated, where each digit in the sequence is corresponding to one data block. In some embodiments, a 0 indicates that the data block does not need to be encrypted, and a 1 indicates that the data block needs to be encrypted. Certainly, a person of ordinary skill in the art easily understands that there are various different methods for implementing the random number generator. For a well-known method, details are not described herein again. It should be noted that in this embodiment, 0 and 1 in the 0-1 sequence are merely two opposite identifiers that may be distinguished, and either of them may be used to indicate that a corresponding data block should be encrypted or unencrypted. In addition, 0 and 1 are merely two state examples in this embodiment, and this embodiment sets no specific limitation thereto.

In this embodiment, when the preset rule includes multiple selection algorithms and algorithm identifiers of the multiple selection algorithms, a first step may include determining a specific algorithm for performing data block selection. For example, the preset rule may include three selection algorithms described according to the following. An identifier x represents that an even number is selected. An identifier y represents that an odd number is selected. An identifier z represents that selection is performed at an interval of two data blocks, starting from the first data block. On a basis of the preset rule, first it is determined by using the identifier x that a selection algorithm used this time is selecting an even number. Then all even data blocks are extracted from the media data in order to perform a subsequent encryption operation. It should be noted that this embodiment sets no specific limitation on a to-be-used algorithm identifier, but in a process of an encryption and decryption operation both parties need to use a same algorithm identifier to determine a selection algorithm. Based on the algorithm identifier, an encryption operation is performed or an encrypted data block is determined. Details are not described again in this embodiment.

On a basis of the above, if the preset rule is unknown, encrypted data blocks cannot be learned. Specifically, if content included in the preset rule is unknown, data restoration cannot be correctly performed either. Therefore, in addition to encryption, media data security may be further enhanced.

In step 130, the requester receives the media data and determines an encrypted data block in the media data using the preset rule shared with the sender.

Specifically, in this embodiment, the media data received by the requester includes a part of encrypted data blocks and another part of unencrypted data blocks. The requester selects the encrypted data block using the preset rule shared with the sender. The preset rule used by the requester may be shared with the sender according to the following not limiting embodiments. The preset rule sent by the sender is received through a secure channel. The preset rule notified by the sender is acquired in a public manner. The preset rule is preset in both the requester and the sender. The preset rule is negotiated and determined by exchanging information with the sender. Details are not described again in this specification.

It should be noted that the requester may learn, in the foregoing multiple manners, the preset rule shared with the sender. Therefore, when the random number generator is used to implement the selection operation, the requester may determine the encrypted data block as long as the requester learns parameters. These parameters may include, for example, a random number generator algorithm, an initial value, the occurrence probability p of 1, and an initial number of a data block that are in the preset rule. A specific determining process is similar to that of the sender, and details are not described herein again in this embodiment.

In step 140, the requester performs decryption processing on the encrypted data block to obtain original media data.

In this embodiment, the media data received by the requester includes the part of encrypted data blocks. Therefore, if it is required to learn the original media data, the encrypted data blocks are determined and the original media data is acquired after the encrypted data blocks are decrypted. It should be noted that in this embodiment, the encryption and decryption operation may be implemented by using standards such as, for example, a data encryption standard (DES) or an advanced encryption standard (AES) issued by the National Institute of Standards and Technology (NIST). However, this embodiment sets no limitation on an encryption and decryption method and any encryption and decryption methods fall within the scope of the present invention. In another aspect, the method in the present invention is applied to media data transmission. The method is independent of content and includes a content expression (that is, media coding or source coding), and may be applicable to different media coding.

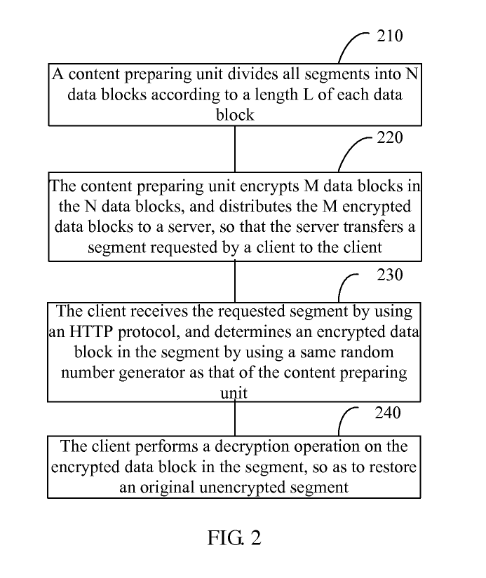

The following uses a specific example to describe in detail the method for implementing media data processing in the foregoing embodiment. As shown in FIG. 2, in Embodiment 2, an application in HTTP streaming is used as an example. In an HTTP streaming service, a coding version of media content is referred to as a coding expression. The coding expression is divided into several media segments in a time domain, and a uniform resource locator (URL) is allocated to each segment. Each coding expression has an initialized segment and the initialized segment only includes metadata of media coding, but excludes coding data of media content. A coding expression includes one initialized segment and several (at least one) media segments. Both the initialized segment and the media segment are collectively referred to as segments.

In step 210 a content preparing unit divides a segment (which includes a media segment and an initialized segment) in HTTP streaming into N data blocks according to a length L of each data block. A length of the last data block may be less than L and lengths of other data blocks are the same.

In step 220 the content preparing unit encrypts M data blocks in the N data blocks and distributes the M encrypted data blocks to a server that supports an HTTP protocol. After receiving a request from a client, the server transfers a segment requested by the client to the client.

To enable a requester to successfully complete a decryption operation, a length L of a data block or a quantity N of encrypted data blocks is transferred as a parameter to the requester. Specifically, in this embodiment, the content preparing unit randomly generates a 0-1 sequence using a random number generator where a total quantity of 0 and 1 in the 0-1 sequence is N, a quantity of 1 is M, and an ith data block is corresponding to an ith digit in the sequence. If a figure corresponding to the ith data block is 1, it indicates that encryption processing may to be performed on the ith data block. Then the content preparing unit performs an encryption operation on the data block. The content preparing unit performs encryption operations on a total of M data blocks.

For an HTTP streaming application, information, which is described in the present invention, about the media data division and a preset rule may be included in a media presentation description (MPD) file. Before performing content distribution, the content preparing unit generates the media presentation description (MPD) file. Information about a division method, a preset rule, and the like that are used by the content preparing unit is described, and the client acquires the media presentation description file before requesting a segment. Thereby, it may be ensured that a division method and a preset rule, which are used by the client, of the media data are in complete conformity with those used by the content preparing unit. As an example, several extensible markup language (XML) data units and properties are defined in MPD. Refer to the following Table 1 below.

TABLE 1
Data units and properties

| Data Unit or Property | | |
|---|---|---|
| Content Protection | Usage | Description |
| @schemeIdUri | Required | Describes a universal resource |
| | | identifier (URI) to identify a |
| | | content protection solution used. |
| | | Indicates inter-segment encryption |
| | | if equal to “inter-segment encryp- |
| | | tion.” |
| | | Indicates intra-segment encryption |
| | | if equal to “intra-segment encryp- |
| | | tion”. |
| @blockSize | Optional | Describes a length, which is indi- |
| | | cated by byte, of a data block. |
| | | The property is present only when |
| | | the property @scheme is “intra- |
| | | segment encryption.” |
| | | If @scheme is other value than |
| | | “intra-segment encryption”, |
| | | it shall not be present. |
| @selectionAlgorithmID | Required | Describes a selection algorithm |
| @seed | Optional | The property is present only when |
| | | an algorithm indicated by |
| | | @selectionAlgorithmId is a |
| | | random number generation |
| | | algorithm. |
| | | It is used to initialize a random |
| | | number generator, and determine |
| | | an initial state of the random |
| | | number generator. |
| @p1 | Optional | The property is present only when |
| | | an algorithm indicated by |
| | | @selectionAlgorithmId is a |
| | | random number generation |
| | | algorithm. |
| | | It describes a probability that |
| | | 1 is generated by the random |
| | | number generation algorithm. |

A data unit is indicated by a bold character, and a property is identified by a prefix @.

Different data structures may be defined in MPD to describe the information about the division method, the preset rule, and the like that are used by the content preparing unit.

In step 230, the client receives a requested segment using the HTTP protocol and determines an encrypted data block in the segment using a random number generator algorithm and an initial value that are the same as those of the content preparing unit. A specific determining process of the encrypted data block is the same as that of the foregoing content preparing unit and details are not described herein again.

In step 240, the client performs a decryption operation on the encrypted data block in the segment in order to restore an original unencrypted segment.

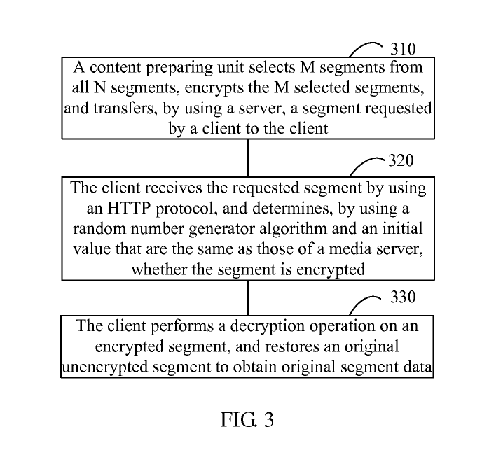

The following uses a specific example to describe in detail the method for implementing media data processing in the foregoing embodiment. As shown in FIG. 3, in Embodiment 3, an application in HTTP streaming is still used as an example:

In step 310, a content preparing unit selects M segments from N segments in the HTTP Streaming, encrypts the M selected segments, and distributes the M encrypted segments to a server that supports an HTTP protocol. After receiving a request from a client, the server transfers, using the HTTP protocol, a segment requested by the client to the client.

Similarly, in this embodiment, the content preparing unit randomly generates a 0-1 sequence using a random number generator, where a total quantity of 0 and 1 in the 0-1 sequence is N, a quantity of 1 is M, and an i^{th} segment is corresponding to an i^{th} digit in the sequence. If a figure corresponding to the i^{th} segment is 1, it indicates that encryption processing should be performed on the i^{th} segment. Then the content preparing unit performs an encryption operation on the segment. The content preparing unit performs encryption operations on a total of M segments.

In step 320, the client receives the segment using the HTTP protocol and determines, using a random number generator algorithm and an initial value that are the same as those of the content preparing unit, whether the segment is encrypted. A specific determining process is the same as that of the foregoing content preparing unit and details are not described herein again.

In step 330, the client performs a decryption operation on the encrypted segment in order to restore an original unencrypted segment.

It may be learned that in a method according to embodiments, partial encryption is performed on media data in order that transmitted data combines encrypted data and unencrypted data and a requester decrypts only an encrypted part of the several data. Thereby, a system resource overhead may be effectively reduced in a case in which media data security is ensured.

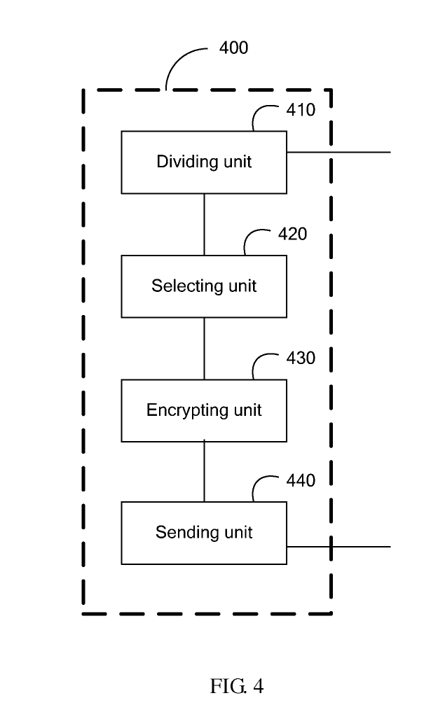

On a basis of a same idea as that in the foregoing, Embodiment 4 further proposes an apparatus for implementing media data processing. As shown in FIG. 4, the apparatus 400 includes a dividing unit 410, a selecting unit 420, an encrypting unit 430, and a sending unit 440.

The dividing unit 410 is configured to divide media data into several data blocks. The selecting unit 420 is configured to select, using a preset rule, a part of the several data blocks obtained through dividing by the dividing unit 410. The encrypting unit 430 is configured to encrypt the part of the several data blocks selected by the selecting unit 420. The sending unit 440 is configured to send the encrypted part of the several data blocks and an unencrypted data block in the several data blocks to the requester when a data acquiring request from a requester is received. The requester may determine the encrypted part of the several data blocks according to the preset rule. In such embodiments, the selecting unit 420 and the requester share the preset rule.

In addition, the apparatus 400 may further include (not shown in the figure) a first sharing unit that is configured to send the preset rule used by the selecting unit to the requester through a secure channel. In another embodiment, the first sharing unit may be configured to notify, in a public manner, the requester of the preset rule used by the selecting unit. In another embodiment, the first sharing unit may preset the preset rule in the selecting unit and in the requester. In another embodiment, the first sharing unit may negotiate and determine the preset rule used by the selecting module by exchanging information with the requester.

The selecting unit 420 further includes (not shown in the figure) a first random number generator, a first matching module, and a first processing module. The first random number generator is configured to generate a random variable sequence according to a random number generation algorithm included in the preset rule. The random variable sequence includes a first variable that represents a first state and a second variable that represents a second state. The first matching module is configured to associate the first variable and the second variable in the random variable sequence with the several data blocks. Each data block in the several data blocks is corresponding to only one variable in the random variable sequence. The first processing module is configured to determine, according to a variable corresponding to the data block, whether the data block should be encrypted. The first processing module is also configured to notify the encrypting unit 430.

It should be noted that the selecting unit 420 may further include (not shown in the figure) a first determining module and a first extracting module. The first determining module is configured to determine a selection algorithm using an algorithm identifier of the requester. The algorithm identifier is included in the preset rule. The first extracting module is configured to extract, from the media data, a data block that complies with the selection algorithm determined by the first determining module. The first extracting module is also configured to instruct the encrypting unit 430 to perform an encryption operation.

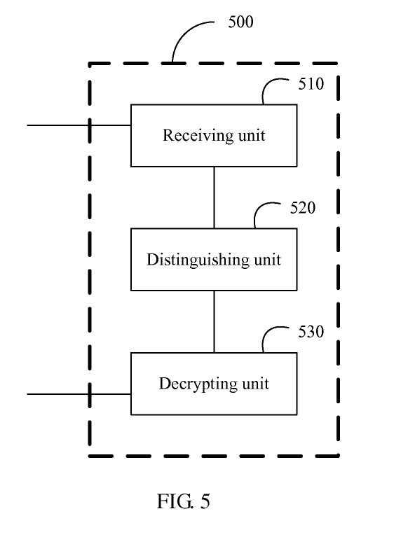

On a basis of a same idea as that in the foregoing, Embodiment 5 further proposes an apparatus for implementing media data processing. As shown in FIG. 5, the apparatus 500 includes a receiving unit 510, a distinguishing unit 520, and a decrypting unit 530.

The receiving unit 510 is configured to acquire media data from a sender. The distinguishing unit 520 is configured to determine, by using a preset rule shared with the sender, an encrypted data block in the media data received by the receiving unit 510. The decrypting unit 530 is configured to perform a decryption operation on the encrypted data block determined by the distinguishing unit 520.

In addition, the apparatus 500 may further include (not shown in the figure) a second sharing unit that is configured to receive, through a secure channel, the preset rule sent by the sender and used by the distinguishing unit 520. In another embodiment, the second sharing unit may acquire, in a public manner, the preset rule notified by the sender and used by the distinguishing unit 520. In another embodiment, the second sharing unit may preset, in the distinguishing unit 520, the preset rule which is the same as that of the sender. In another embodiment, the second sharing unit may negotiate and determine the preset rule used by the distinguishing unit 520 by exchanging information with the sender.

The distinguishing unit 520 may further include (not shown in the figure) a second random number generator, a second matching module, and a second processing module.

The second random number generator is configured to generate a random variable sequence according to a random number generation algorithm included in the preset rule. The random variable sequence includes a first variable that represents a first state and a second variable that represents a second state. The second matching module is configured to associate the first variable and the second variable in the random variable sequence with several data blocks. Each data block in the several data blocks is corresponding to only one variable in the random variable sequence. The second processing module is configured to determine, according to a variable corresponding to the data block, whether the data block is an encrypted data block. The second processing module is also configured to instruct the decrypting unit 530 to perform the decryption operation.

In addition, the distinguishing unit 520 may further include (not shown in the figure) a second determining module and a second extracting module. The second determining module determines a selection algorithm according to an algorithm identifier of the encryption device. The second extracting module is configured to extract, from the received media data, a data block that complies with the selection algorithm determined by the second determining module and instruct the decrypting unit 530 to perform a subsequent decryption operation.

It should be noted that a person skilled in the art easily understands that various apparatuses for implementing media data processing described in the foregoing embodiments may also exist as a part of another system and implement, in the system, media data processing consistent with the descriptions in the foregoing embodiments. Therefore, a system that includes the apparatus for implementing media data processing in the foregoing embodiments shall fall within the protection scope of the present application and details are not described herein again.

A person skilled in the art may be further aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the embodiments of the present invention.

In combination with the embodiments disclosed in this specification, method or algorithm steps may be implemented by hardware, a software module executed by a processor, or a combination thereof.

The foregoing descriptions of the disclosed embodiments enable a person skilled in the art to implement or use the embodiments of the present invention. Various modifications to the embodiments are obvious to the person skilled in the art, and general principles defined in this specification may be implemented in other embodiments without departing from the spirit or scope of the embodiments of the present invention. Therefore, the embodiments of the present invention will not be limited to the embodiments described in this specification but extend to the widest scope that complies with the principles and novelty disclosed in this specification.

The foregoing descriptions are merely exemplary embodiments of the present invention, but are not intended to limit the embodiments of the present invention. Any modification, equivalent replacement, and improvement made without departing from the spirit and principle of the embodiments of the present invention shall fall within the protection scope of the embodiments of the present invention.

What is claimed is:

1. A method for implementing media data processing, the method comprising:
dividing media data into several data blocks;
selecting a part of the several data blocks using a preset rule;
encrypting the selected part of the several data blocks;
when a data acquiring request from a requester is received, sending requested data to the requester, wherein the requested data comprises part of the several data blocks; and
sharing the preset rule with the requester, such that the requester can determine the encrypted part of the several data blocks according to the preset rule.

2. The method according to claim 1, wherein the part of the several data blocks comprises the encrypted part of the several data blocks.

3. The method according to claim 1, wherein the part of the several data blocks comprises an unencrypted data block in the several data blocks.

4. The method according to claim 1, wherein the part of the several data blocks comprises both the encrypted part of the several data blocks and an unencrypted data block in the several data blocks.

5. The method according to claim 1, wherein sharing the preset rule with the requester comprises:
sending the preset rule to the requester through a secure channel; or
notifying the requester of the preset rule in a public manner; or
presetting the preset rule in the requester; or
negotiating and determining the preset rule by exchanging information with the requester.

6. The method according to claim 1, wherein, when the preset rule comprises a random number generation algorithm, selecting a part of the several data blocks using a preset rule comprises generating a random variable sequence according to the random number generation algorithm, wherein
the random variable sequence comprises a first variable that represents a first state and a second variable that represents a second state;
the first variable and the second variable in the random variable sequence are associated with the several data blocks;
each data block in the several data blocks is corresponding to only one first variable or second variable in the random variable sequence; and
each data block is encrypted or not encrypted based on the first variable and the second variable.

7. The method according to claim 1, wherein the preset rule comprises multiple selection algorithms and algorithm identifiers, and selecting a part of the several data blocks using a preset rule comprises:
determining a selection algorithm using an algorithm identifier of the requester; and
extracting, from the media data, a data block that complies with the selection algorithm to perform a subsequent encryption operation.

8. A method for implementing media data processing, the method comprising:
receiving media data processed by an encryption device, wherein the media data comprises several data blocks;
determining an encrypted data block in the media data using a preset rule shared with the encryption device; and
performing decryption processing on the encrypted data block to obtain original media data.

9. The method according to claim 8, further comprising:
receiving the preset rule sent by the encryption device through a secure channel; or
acquiring the preset rule notified by a decryption device in a public manner; or
presetting the preset rule; or
negotiating and determining the preset rule by exchanging information with the encryption device.

10. The method according to claim 8, wherein, when the preset rule comprises a random number generation algorithm, determining an encrypted data block in the media data using the preset rule comprises generating a random variable sequence according to the random number generation algorithm, wherein
the random variable sequence comprises a first variable that represents a first state and a second variable that represents a second state;
the first variable and the second variable in the random variable sequence are associated with the several data blocks;
each data block in the several data blocks is corresponding to only one first variable or second variable in the random variable sequence; and
the first variable and the second variable are used to distinguish whether the data block is an encrypted data block.

11. The method according to claim 8, wherein when the preset rule comprises multiple selection algorithms and algorithm identifiers, determining an encrypted data block in the media data using the preset rule comprises:
determining the selection algorithm using an algorithm identifier of the encryption device; and
extracting, from the received media data, a data block that complies with the selection algorithm to perform a subsequent decryption operation.

12. An apparatus for implementing media data processing, the apparatus comprising:
a dividing unit configured to divide media data into several data blocks;
a selecting unit configured to select, using a preset rule, a part of the several data blocks obtained through dividing by the dividing unit;
an encrypting unit configured to encrypt the part of the several data blocks selected by the selecting unit; and
a sending unit configured to, when a data acquiring request from a requester is received, send the encrypted part of the several data blocks and an unencrypted data block in the several data blocks to the requester, wherein the selecting unit and the requester share the preset rule such that the requester can determine the encrypted part of the several data blocks according to the preset rule.

13. The apparatus according to claim 12, wherein the apparatus further comprises a first sharing unit configured to:
send, through a secure channel, the preset rule used by the selecting unit to the requester; or
notify, in a public manner, the requester of the preset rule used by the selecting unit; or
preset the preset rule in the selecting unit; or
negotiate and determine the preset rule used by the selecting unit by exchanging information with the requester.

14. The apparatus according to claim 12, wherein the selecting unit further comprises:
a first random number generator configured to generate a random variable sequence according to a random number generation algorithm comprising the preset rule, wherein the random variable sequence comprises a first variable that represents a first state and a second variable that represents a second state;
a first matching module configured to associate the first variable and the second variable in the random variable sequence with the several data blocks, wherein each data block in the several data blocks is corresponding to only one first variable or second variable in the random variable sequence; and
a first processing module configured to
determine whether to encrypt each data block according to a variable corresponding to the data block, and
notify the encrypting unit.

15. The apparatus according to claim 12, wherein the selecting unit further comprises:
a first determining module configured to determine a selection algorithm by using an algorithm identifier of the requester, wherein the algorithm identifier comprises the preset rule; and
a first extracting module configured to
extract a data block from the media data that complies with the selection algorithm determined by the first determining module, and
instruct the encrypting unit to perform an encryption operation.

16. An apparatus for implementing media data processing, the apparatus comprising:
a receiving unit configured to receive media data processed by an encryption device, wherein the media data comprises several data blocks;
a distinguishing unit configured to determine, using a preset rule shared with the encryption device, an encrypted data block in the media data received by the receiving unit; and
a decrypting unit configured to perform a decryption operation on the encrypted data block determined by the distinguishing unit.

17. The apparatus according to claim 16, wherein the apparatus further comprises a second sharing unit configured to:
receive, through a secure channel, the preset rule sent by the encryption device and used by the distinguishing unit; or
acquire, in a public manner, the preset rule notified by the encryption device and used by the distinguishing unit; or
preset the preset rule in the distinguishing unit; or
negotiate and determine the preset rule used by the distinguishing unit by exchanging information with the encryption device.

18. The apparatus according to claim 16, wherein the distinguishing unit further comprises:
a second random number generator configured to generate a random variable sequence according to a random number generation algorithm comprising the preset rule, wherein the random variable sequence comprises a first variable that represents a first state and a second variable that represents a second state;
a second matching module configured to associate the first variable and the second variable in the random variable sequence with the several data blocks, wherein each data block in the several data blocks is corresponding to only one first variable or second variable in the random variable sequence; and
a second processing module configured to
determine, according to a variable corresponding to the data block, whether the data block is an encrypted data block, and
instruct the decrypting unit to perform the decryption operation.

19. The apparatus according to claim 16, wherein the distinguishing unit further comprises:
a second determining module configured to determine a selection algorithm by using an algorithm identifier of the encryption device, wherein the algorithm identifier is comprises the preset rule; and
a second extracting module configured to
extract, from the received media data, a data block that complies with the selection algorithm determined by the second determining module, and
instruct the decrypting unit to perform a subsequent decryption operation.
